(19) United States
(12) Patent Application Publication
(10) Pub. No.: US 2012/0034057 A1
(43) Pub. Date: Feb. 9, 2012

(54) STORAGE WAGON FOR TRANSPORTING BULK MATERIAL, AND A METHOD

(75) Inventors: Josef Teurer, Wien (AT); Manfred Brunninger, Altenberg (AT)

(73) Assignee: FRANZ PLASSER BAHNBAUMASCHINEN- INDUSTRIEGESELLSCHAFTMBH, Wien (AT)

(21) Appl. No.: 13/263,363

(22) PCT Filed: Feb. 26, 2010
(86) PCT No.: PCT/EP10/01184

§ 371 Date: Oct. 7, 2011

(30) Foreign Application Priority Data
Apr. 7, 2009 (AT) A 544/2009

(51) Int. Cl. B60P 1/36

(52) U.S. Cl. 414/503; 414/813

(57) ABSTRACT

A storage cart for transporting bulk goods has a floor conveyor belt disposed within a container and serving as a floor surface, and a transfer conveyor belt positioned at a front end of the cart and protruding beyond the end. A loading conveyor belt is displaceable in a longitudinal axis of the cart. A lifting device and an operator cab are provided at a rear end of the cart. The above are disposed directly on the loading conveyor belt in a segment of the loading conveyor belt directly adjacent to a receiving end.

The invention relates to a storage wagon for transporting bulk material, including a bottom conveyor belt extending in a longitudinal direction of the wagon, which is arranged within a container and serves as a bottom surface and comprises a receiving- and discharge end, and also including a transfer conveyor belt positioned at a front end of the wagon and projecting beyond the same, wherein a loading conveyor belt, displaceable in the longitudinal direction of the wagon, as well as an excavating device and a work cabin are provided at a rear end of the wagon.

Further, the invention also relates to a method for putting the loading conveyor belt into operation.

A storage wagon of this type is known from WO 2007/116249 A3. The excavating device is fastened, together with a work cabin, directly on the wagon frame, with the loading conveyor belt being displaceable relative to the wagon frame into a working position. A solution with this kind of structure permits only a limited width and length of the loading conveyor belt.

It is the object of the present invention to provide a storage wagon of the type mentioned at the beginning, or a method, which makes it possible to perform a more efficient loading operation.

According to the invention, this object is achieved with a storage wagon of the specified type in that the excavating device and the work cabin are arranged directly on the loading conveyor belt in a section of the loading conveyor belt immediately adjoining a receiving end.

This structural solution allows the loading conveyor belt to be designed with greater width and thus greater efficiency, since the excavating device together with the work cabin is arranged above the loading conveyor belt. Additionally, optimal positioning of both the excavating device and the work cabin close to the excavation site is ensured.

With the method according to the invention, a very simple change between working- and transfer position is possible even in the case of a heavier loading conveyor belt designed for greater efficiency.

Additional advantages of the invention become apparent from the dependent claims and the drawing description.

The invention will be described in more detail below with reference to embodiments represented in the drawing in which

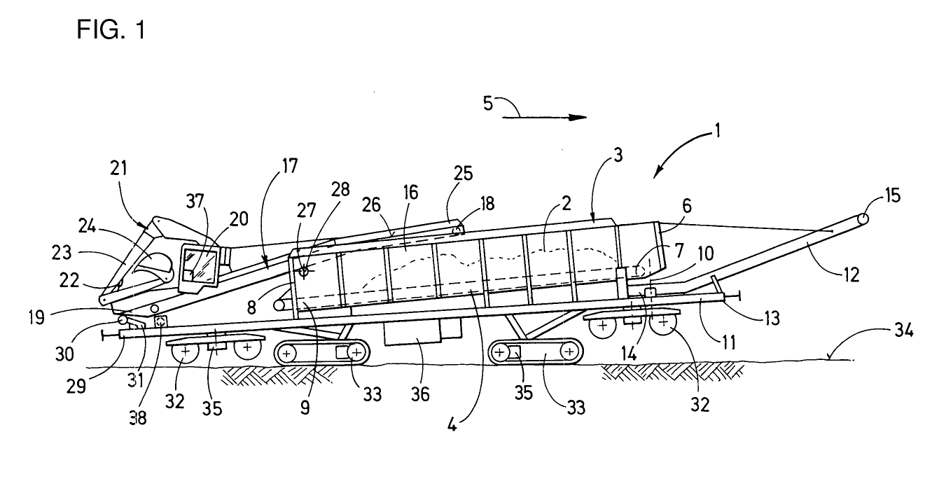

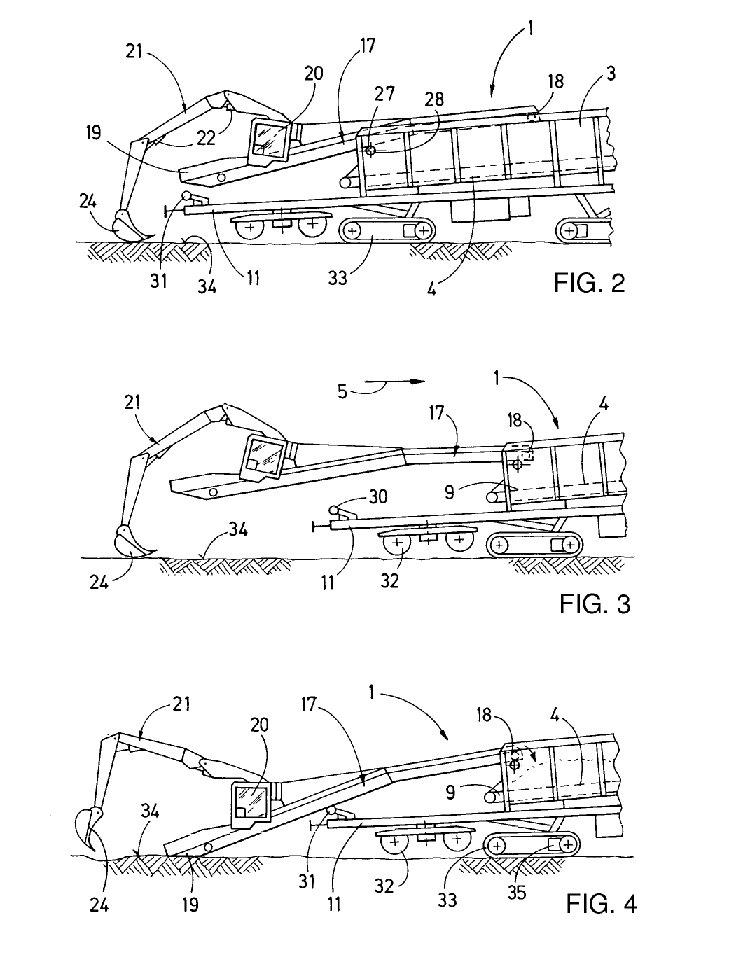

FIG. 1 shows a side view of a storage wagon having a loading conveyor belt, and FIGS. 2 to 4 show a variant of a method for transferring the loading conveyor belt into the working position.

A storage wagon 1, visible in FIG. 1, for transporting bulk material 2 has a container 3 with a bottom conveyor belt 4 serving as a bottom surface. Said bottom conveyor belt 4 has a discharge end 7, positioned at a front end 6 of the container 3 with regard to a longitudinal direction 5 of the wagon, and a receiving end 9 situated at a rear end 8 of the container 3.

Provided at a front end 13 of the wagon is a transfer conveyor belt 12 which is pivotable about an axis 10 and projects beyond a wagon frame 11. The transfer conveyor belt 12 has a receiving end 14, situated underneath the discharge end 7 of the bottom conveyor belt 4, and a discharge end 15 positioned higher in relation to the former.

Arranged in an upper end region 16 of the container 3 is a loading conveyor belt 17, extending in the longitudinal direction 5 of the wagon, which has a front discharge end 18 and a rear receiving end 19. A work cabin 20 and an excavating device 21 are connected to the loading conveyor belt 17 in a section immediately adjoining the receiving end 19. The excavating device 21 is configured as an excavator boom 23 which is pivotable and changeable as to its length by means of drives 22 and has an excavator shovel 24.

In the transfer position, a front end 25—in the longitudinal direction 5 of the wagon—of the loading conveyor belt 17 rests on a belt support 28 in the shape of a roller. Arranged at a rear end 29 of the wagon is a second belt support 31 having support rollers 30 for resting the loading conveyor belt 17 on.

The wagon frame 11 is mobile on a track or, selectively, on a ballast bed or ground surface 34 by means of two on-track undercarriages 32 as well as two vertically adjustable crawler undercarriages 33. A motor 36 serves for actuating motive drives 35 and the various other drives. The work cabin 20, directly connected to the loading conveyor belt 17, is equipped with a control device 37 for actuation of various drives 22 of the excavating device 21.

The storage wagon 1—expediently together with several storage wagons coupled to the front end of the wagon—is driven on a track to a construction site. During this, the loading conveyor belt 17 is in a transfer position, shown in FIG. 1, in which the entire loading conveyor belt 17 is situated above the wagon frame 11, or in the upper end region of the container 3.

In order to transfer the loading conveyor belt 17 into a working position visible in FIG. 4, a winch 38 is actuated. The latter causes a longitudinal displacement of the loading conveyor belt 17, resting on the belt supports or support rollers 28, 30, relative to the storage wagon 1 into a working position shown in FIG. 4. In this position, on the one hand, the excavating device 21 and the work cabin 20 are situated immediately above the ballast bed 34 and, on the other hand, the discharge end 18 is situated above the receiving end 9 of the bottom conveyor belt 4. Thus, bulk material taken up by the excavator shovel 24 can now be discharged upon the receiving end 19 and in further sequence, via the discharge end 18 of the loading conveyor belt 17, upon the bottom conveyor belt 4. The loading conveyor belt 17 is moved back into the transfer position again by actuation of the winch 38.

A second, alternative method for putting the loading conveyor belt 17 into operation will be described in more detail below. As soon as the storage wagon 1 has entered the track-less construction site with the aid of the lowered crawler undercarriages 33, the receiving end 19 of the loading conveyor belt 1 is lifted relative to the wagon frame 11 by lowering the excavator shovel 24 upon the ground surface 34 (see FIG. 2). During this, the loading conveyor belt 17 is swivelled slightly about axes 27 of the two belt supports 28. Subsequently, the storage wagon 1 is moved in the longitudinal direction 5 of the wagon while being distanced from the locally unmoved excavator shovel 24, until the discharge end 18 of the loading conveyor belt 17 comes to lie above the receiving end 9 of the bottom conveyor belt 4 (see FIG. 3).

In further sequence, the excavator shovel 24 is raised relative to the loading conveyor belt 17 until the receiving end 19 thereof rests on the ground surface 34 (FIG. 4).

In order to displace the loading conveyor belt 17 into the transfer position, the receiving end 19 is lifted slightly by pressing the excavator shovel 24 against the ballast bed. Subsequently, the storage wagon 1 is moved in the direction towards the excavator shovel 24 by actuation of the motive drive 35. With this, the loading conveyor belt 17 is automatically displaced into the transfer position situated above the wagon frame 11. This retracting motion may be assisted by the second belt support 31.

1-2. (canceled)

3. A storage wagon for transporting bulk material, the storage wagon comprising:
a container;
a bottom conveyor belt extending in a longitudinal direction of the storage wagon and disposed within said container and serving as a bottom surface, said bottom conveyor belt having a first receiving end and a discharge end;
a transfer conveyor belt positioned at a front end of the storage wagon and projecting beyond the front end;
a loading conveyor belt displaceable in the longitudinal direction of the storage wagon;
an excavating device disposed at a rear end of the storage wagon;
a work cabin disposed at said rear end of the storage wagon; and
said excavating device and said work cabin disposed directly on said loading conveyor belt in a section of said loading conveyor belt immediately adjoining a second receiving end.

4. A method for putting into operation a loading conveyor belt displaceable in a longitudinal direction of a storage wagon, which comprises the steps of:
lifting a receiving end of the loading conveyor belt relative to a wagon frame of the storage wagon by lowering an excavator shovel of the storage wagon upon a ground surface;
subsequently moving the storage wagon while being distanced from the excavator shovel until a discharge end of the loading conveyor belt comes to lie above a receiving end of a bottom conveyor belt of the storage wagon; and
lifting the excavator shovel relative to the loading conveyor belt until the receiving end of the loading conveyor belt rests on the ground surface.
